(19) United States
(12) Patent Application Publication
(10) Pub. No.: US 2015/0220493 A1
(43) Pub. Date: Aug. 6, 2015

(54) DISPLAY CONTROL APPARATUS, DISPLAY CONTROL METHOD AND NON-TRANSITORY COMPUTER READABLE MEDIUM

(71) Applicant: FUJI XEROX CO., LTD., Tokyo (JP)

(72) Inventors: Eisaku HAYASHI, Yokohama-shi (JP); Hiroyuki SAYUDA, Yokohama-shi (JP); Daisuke TATSUMI, Yokohama-shi (JP); Takeshi ONISHI, Yokohama-shi (JP)

(73) Assignee: FUJI XEROX CO., LTD., Tokyo (JP)

(21) Appl. No.: 14/688,538

(22) Filed: Apr. 16, 2015

Related U.S. Application Data
(63) Continuation of application No. PCT/JP2013/069460, filed on Jul. 18, 2013.

(30) Foreign Application Priority Data
Jan. 21, 2013 (JP) 2013-008686

(51) Int. Cl. G06F 17/21

(52) U.S. Cl. CPC G06F 17/212

(57) ABSTRACT

There is provided a display control apparatus. An acquisition unit acquires document information including a main body and information on one or a plurality of charts. A first display control unit causes at least a portion of the maim body included in the document information to be displayed on a first display screen. A second display control unit causes, among the one or plurality of charts, a chart associated with the portion of the main body displayed on the first display screen to be displayed on a second display screen.

### CROSS-REFERENCE TO RELATED APPLICATIONS

This is a continuation of International Application No. PCT/JP2013/069460 filed on Jul. 18, 2013, and claims priority from Japanese Patent Application No. 2013-008686, filed on Jan. 21, 2013.

### TECHNICAL FIELD

The present invention relates to a display control apparatus, display control method and a non-transitory computer readable medium.

### SUMMARY

According to an aspect of the exemplary embodiments of the present invention, there is provided a display control apparatus including an acquisition unit that acquires document information including a main body and information on one or a plurality of charts, a first display control unit that causes at least a portion of the main body included in the document information to be displayed on a first display screen, and a second display control unit that causes, among the one or plurality of charts, a chart associated with the portion of the main body displayed on the first display screen to be displayed on a second display screen.

### BRIEF DESCRIPTION OF DRAWINGS

Exemplary embodiments of the present invention will be described in detail based on the following figures, wherein:

FIG. 1 is a functional block diagram illustrating a display control apparatus according to a first exemplary embodiment;

FIG. 2 is a diagram illustrating an example of an electric document;

FIG. 3 is a diagram illustrating an example of a document management table;

FIG. 4 is a diagram illustrating an example of a text document;

FIG. 5 is a diagram illustrating an example of display of a first display screen and a second display screen;

FIG. 6 is a flowchart for explaining an overall flow of a display target document display process;

FIG. 7 is a flowchart for explaining an example of a second display screen display process;

FIG. 8 is a diagram illustrating an example of a data element correspondence table;

FIG. 9 is a flowchart for explaining an overall flow of a display target data display process;

FIG. 10 is a diagram illustrating an example of the data element correspondence table;

FIG. 11 is a diagram illustrating an example of display of the first display screen and the second display screen;

FIG. 12 is a diagram illustrating an example of the data element correspondence table; and

FIG. 13 is a diagram illustrating an example of display of the first display screen and the second display screen.

### DETAILED DESCRIPTION

In the following, exemplary embodiments for realizing the present invention (hereinafter referred to as exemplary embodiments) will be explained with reference to the drawings.

### [1. First Exemplary Embodiment]

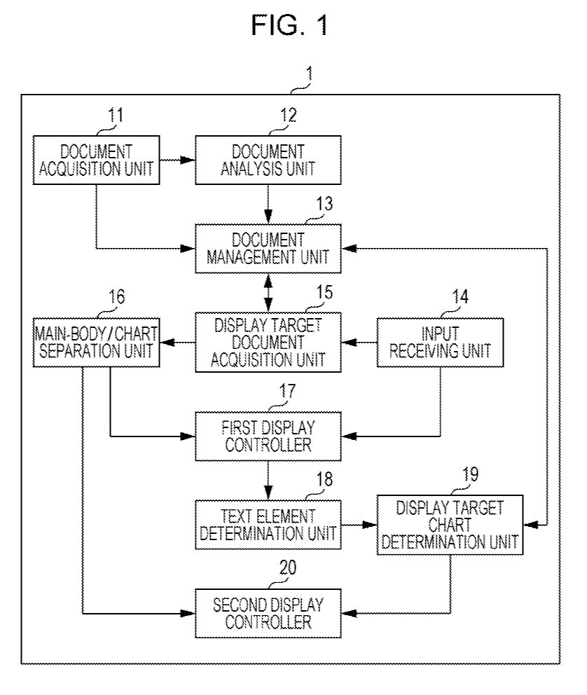

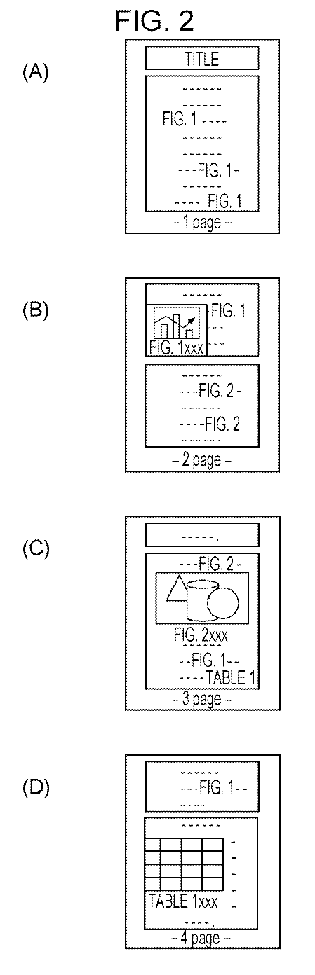

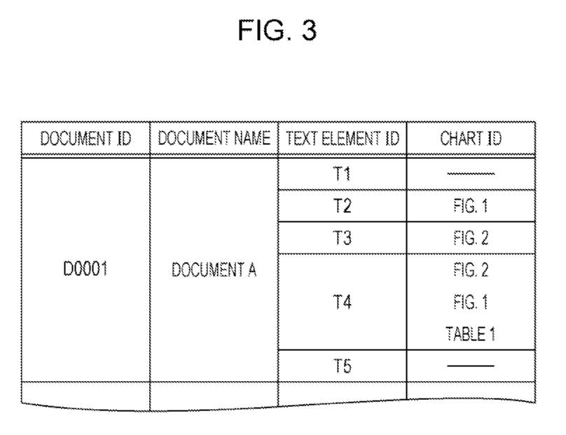

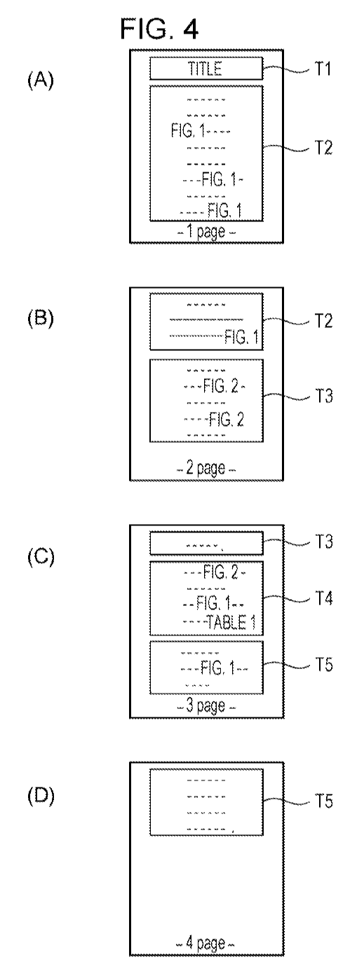

First, a first exemplary embodiment of the present invention will be explained with reference to FIGS. 1 to 7. In the first exemplary embodiment, a process is executed in which, for document information including a main body and charts, the main body is displayed on a first display screen and charts corresponding to the main body displayed on the first display screen are displayed on a second display screen.

### [1.1. Explanation on Functional Blocks]

FIG. 1 illustrates a functional block diagram of a display control apparatus 1 according to the first exemplary embodiment. As illustrated in FIG. 1, the display control apparatus 1 includes a document acquisition unit 11, a document analysis unit 12, a document management unit 13, an input receiving unit 14, a display target document acquisition unit 15, a main-body/chart separation unit 16, a first display controller 17, a text element determination unit 18, a display target chart determination unit 19, and a second display controller 20.

The functions of the above-described units of the display control apparatus 1 may be realized by a computer executing a program stored in a computer-readable information storage medium, the computer including control means such as a CPU, storage means such as a memory, input-output means that transmits and receives data to and from an external device, and the like. Note that the program may also be supplied to the display control apparatus 1, which is a computer, via an information storage medium, examples of which include an optical disc, a magnetic disk, a magnetic tape, a magneto-optical disk, a flash memory, and the like, or via a data communication network such as the Internet.

The document acquisition unit 11 acquires document data to be a management target. In the first exemplary embodiment, document data including text (sentences composed of character strings) and charts are treated as a management target. For example, document data may include an electric document including text data, chart data, and layout data on the text data and chart data and a scanned document obtained by scanning a paper document. Here, a scanned document may be converted into an electric document including text data, chart data, and layout data on the text data and chart data by an optical character recognizing process (an OCR process). In the following, an explanation will be made assuming that document data acquired by the document acquisition unit 11 is an electric document.

FIG. 2 illustrates an example of an electric document. As illustrated in FIG. 2, a plurality of text elements and a plurality of charts are arranged in a mixed manner in the electric document, which is a processing target in the first exemplary embodiment. Parts (A) to (D) of FIG. 2 correspond to pages 1 to 4 of the electric document, respectively. Note that charts may represent information other than character strings such as diagrams, tables, pictures, images representing mathematical expressions, and the like.

The document analysis unit 12 analyzes information on an electric document acquired by the document acquisition unit 11, and determines a correspondence relationship between text elements (text objects) included in the electric document and charts (chart objects) included in the electric document. For example, in the case where the electric document is a structured document including data on text objects (for example, character-string information in units of paragraphs, sentences, words, or the like), chart objects, and layout information on the text objects and the chart objects, the document analysis unit 12 may determine a correspondence relationship between the text objects and the chart objects in accordance with the text objects and identification information of chart objects included in the text objects (for example, character strings such as “FIG. 1”, “Table 1”, and the like). In the case where the electric document is not a structured document, the document analysis unit 12 may convert the electric document into a structured document in accordance with a result of layout analysis and then determine a correspondence relationship between text objects and chart objects within the electric document.

The document management unit 13 manages document data (an electric document) acquired by the document acquisition unit 11 and data on a correspondence relationship between text objects and chart objects within the electric document, the correspondence relationship being determined for the electric document by the document analysis unit 12.

FIG. 3 illustrates an example of a document management table managed by the document management unit 13. In the example of the document management table illustrated in FIG. 3, identification information of an electric document (a document ID), a document name, identification information of a text object (a text element ID) included in the electric document, and identification information of a chart object (a chart ID) included in the electric document corresponding to the text object are associated with one another and stored.

The input receiving unit 14 receives a user operation input from an input device such as a mouse, a keyboard, a touch panel, a camera, or the like. For example, the input receiving unit 14 may receive an input directly from a user through a mouse, a keyboard, or a touch panel. Alternatively, a user operation input is determined in accordance with an image of the user's movement or the user's line-of-sight position captured by the camera, and the input receiving unit 14 may receive the determined operation input.

The display target document acquisition unit 15 reads and acquires an electric document to be a display target (a display target document) from electric documents managed by the document management unit 13, in accordance with an operation input received by the input receiving unit 14.

The main-body/chart separation unit 16 separates text data from chart data included in a display target document acquired by the display target document acquisition unit 15. For example, the main-body/chart separation unit 16 may extract only text objects included in the display target document and generate a text document in which the extracted text objects are arranged.

FIG. 4 illustrates an example of a text document. As illustrated in FIG. 4, the text document is a document in which only text objects of an original display target document are rearranged. Parts (A) to (D) of FIG. 4 correspond to pages 1 to 4 of the text document, respectively. Note that, in the example illustrated in FIG. 4, the text document includes text elements (text objects) T1 to T5.

The first display controller 17 causes a display apparatus such as a built-in liquid crystal display, an external liquid crystal display connected thereto, or the like to display a text document generated about a display target document by the main-body/chart separation unit 16. Here, a display screen on which the text document generated about the display target document is displayed is called a first display screen. In addition, the first display controller 17 may update a display portion of the text document displayed on the first display screen, in accordance with a scroll operation or a scaling operation received by the input receiving unit 14.

The text element determination unit 18 determines text elements (text objects) included in a display portion of a text document displayed on the first display screen by the first display controller 17, in accordance with information on the display portion. In this case, for example, the text element determination unit 18 may assign display ordinal ranks (for example, 1, 2, 3, and the like from the top) to the determined text elements in accordance with the order corresponding to positions where the determined text elements are displayed on the first display screen. In addition, the text element determination unit 18 may also assign a degree of attention to each determined text element in accordance with the position of the text element displayed on the first display screen (for example, the closer to the center of the first display screen, the higher the degree of attention, or the like) or the position of a cursor (for example, the closer to the position of the cursor, the higher the degree of attention, or the like).

The display target chart determination unit 19 determines charts (chart objects) corresponding to text elements (text objects) determined by the text element determination unit 18 and displayed on the first display screen, with reference to a document management table managed by the document management unit 13. Here, the display target chart determination unit 19 may also assign display ordinal ranks (and degrees of attention) to the determined charts (chart objects) in accordance with display ordinal ranks (and degrees of attention) assigned to text elements (text objects) corresponding to the charts.

The second display controller 20 causes a display apparatus such as a liquid crystal display or the like to display a chart document in which at least one or some of charts (chart objects) determined by the display target chart determination unit 19 are arranged. Here, a display screen on which the chart document is displayed is called a second display screen, and, for example, the first display screen and the second display screen may be arranged vertically or horizontally. For example, the second display controller 20 may also cause a chart document in which charts (chart objects) determined by the display target chart determination unit 19 are arranged in the order of display ordinal ranks assigned to respective charts (chart objects) to be displayed on the second display screen. In this case, the second display controller 20 may also arrange the charts (chart objects) determined by the display target chart determination unit 19 in sizes determined in accordance with the degrees of attention assigned to the respective charts (chart objects).

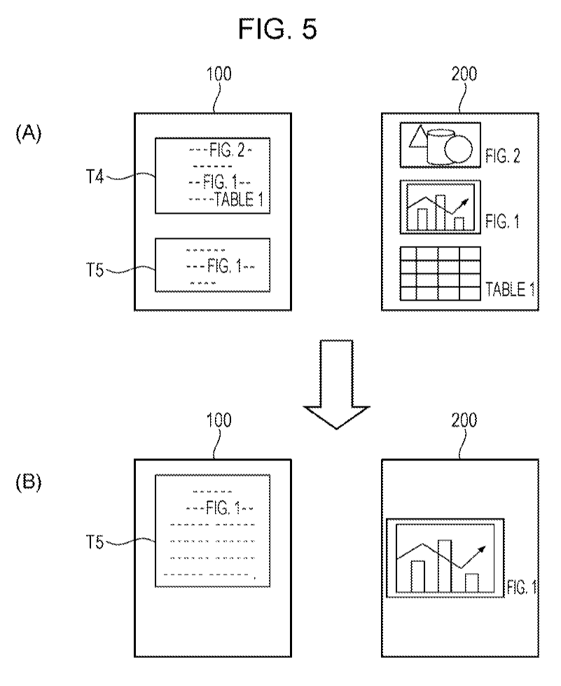

FIG. 5 illustrates an example of display of a first display screen 100 and a second display screen 200. As illustrated in part (A) of FIG. 5, in the case where text elements T4 and T5 are displayed on the first display screen 100, after charts corresponding to the text element T4, which are FIG. 2, FIG. 1, and Table 1, and a chart corresponding to the text element T5, which is FIG. 1, are determined, FIG. 2, FIG. 1, and Table 1 are displayed on the second display screen 200. Note that since there is an overlap between FIG. 1 corresponding to the text element T5 and FIG. 1 corresponding to the text element T4, display of FIG. 1 corresponding to the text element T5 is omitted. In addition, in the case where display of the first display screen 100 is changed from part (A) of FIG. 5 to part (B) of FIG. 5, since only the text element T5 is displayed on the first display screen 100, only FIG. 1 corresponding to the text element T5 is displayed on the second display screen 200.

### [1.2. Explanation on Flowchart]

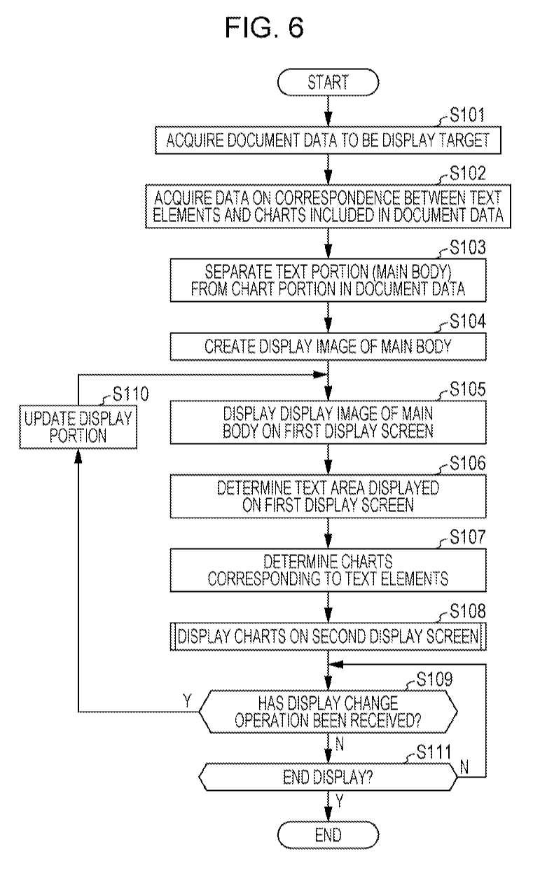

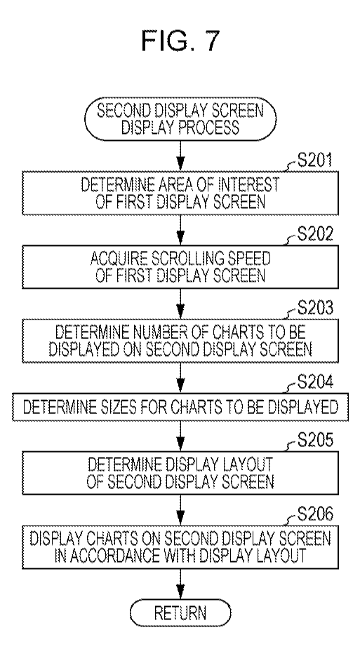

Next, an example of the flow of a process performed by the display control apparatus 1 will be explained with reference to FIG. 6 and FIG. 7.

### [1.2-1. Document Display Process]

FIG. 6 illustrates an example of a flowchart for explaining an overall flow of a display target document display process performed by the display control apparatus 1.

As illustrated in FIG. 6, the display control apparatus 1 reads and acquires document data (an electric document) to be a display target from electric documents managed by the document management unit 13, in accordance with an operation input received by the input receiving unit 14 (S101). In addition, the display control apparatus 1 reads and acquires data indicating a correspondence relationship between text elements (text objects) and charts (chart objects) included in the document data to be the display target, from the document management table managed by the document management unit 13 (S102).

Next, the display control apparatus 1 separates a text portion (the main body) of the document data to be the display target from a chart portion of the document data (S103), and creates a display image of a text document composed of the separated text portion (the main body) (S104).

The display control apparatus 1 displays, on the first display screen, a display portion determined in the display image of the text document (S105), and determines text elements (text objects) displayed on the first display screen (S106). Here, a text element (a text object) displayed on the first display screen may be a text element (a text object) at least a portion of which is displayed, or may also be a text element (a text object) the entirety of which is displayed.

The display control apparatus 1 determines charts (chart objects) corresponding to the text elements (text objects) determined in S106 in accordance with the data indicating the correspondence relationship between the text elements (text objects) and charts (chart objects) included in the document data to be the document target (S107).

The display control apparatus 1 displays the charts (chart objects) determined in S107 on the second display screen (S108). The details of a process will be described later in which these chart objects corresponding to the text objects displayed on the first display screen are displayed on the second display screen.

In the case where a display change operation for changing display of the first display screen has been received by the input receiving unit 14 (S109: Y), the display control apparatus 1 updates a display portion of the display image of the text document, the display portion being displayed on the first display screen, (S110) and the process returns to S105.

In the case where a display change operation for changing display of the first display screen has not been received by the input receiving unit 14 (S109: N) and in the case where display of the document data to be the document target is not ended (S111: N), the process returns to S109. In the case where display of the document data to be the document target is ended (S111: Y), the display control apparatus 1 ends display of the document data and completes the process.

### [1.2-2. Second Display Screen Display Process]

FIG. 7 illustrates a flowchart for explaining an example of a process for displaying, on the second display screen, a chart object corresponding to a text object displayed on the first display screen. Note that the flow illustrated in FIG. 7 explains the details of S108 executed after S107 in FIG. 6.

As illustrated in FIG. 7, the display control apparatus 1 determines an area of interest in the text document displayed on the first display screen in accordance with an operation input received by the input receiving unit 14 (S201). For example, the display control apparatus 1 may select, as the area of interest, the text object closest to a specific area of the first display screen (for example, the center position of the first display screen) among text objects of the text document displayed on the first display screen, or may also select, as the area of interest, a text object specified by a cursor (or a touch operation in the case of a touch panel) among the text objects of the text document displayed on the first display screen.

In addition, the display control apparatus 1 acquires the scrolling speed (a display update speed) of the first display screen in accordance with an operation input received by the input receiving unit 14 (S202).

Next, the display control apparatus 1 determines the number of charts (chart objects) to be displayed on the second display screen among the charts (chart objects) determined in S107 (S203). For example, the display control apparatus 1 determines the maximum number of charts to be displayed on the second display screen, in accordance with the scrolling speed acquired in S202. In the case where the number of charts (chart objects) determined in S107 is less than or equal to the determined maximum number, the display control apparatus 1 may display all the charts (chart objects) determined in S107. In the case where the number of charts (chart objects) determined in S107 is greater than the determined maximum number, the display control apparatus 1 may select the maximum number of charts from among all the charts (chart objects) determined in S107. For example, the display control apparatus 1 may assign degrees of attention to the text objects and the chart objects corresponding to the text objects such that the closer to the area of interest determined in S201, the higher the degree of attention, and may selects the maximum number of chart objects in the order from highest degree of attention assigned.

For each of the charts (chart objects, hereinafter as display target charts) determined as display targets in S203, the display control apparatus 1 determines a display size for the chart (S204). For example, for each display target chart, the display control apparatus 1 may determine the display size of the display target chart to be a size corresponding to the degree of attention assigned to the display target chart (for example, a size proportional to the degree of attention). Alternatively, in the case where the display target charts may be arranged in respective predetermined sizes on the second display screen, the sizes predetermined for the respective display target charts are treated as display sizes. In the case where the display target charts may not be arranged in the respective predetermined sizes on the second display screen, the display size of each of the display target charts may be determined such that the lower the degree of attention of the display target chart, the greater the reduction ratio.

Next, the display control apparatus 1 determines a display layout for arranging the display target charts determined in S203 in the display sizes determined in S204 on the second display screen (S205). For example, the display control apparatus 1 may determine the order in which the text objects are displayed on the first display screen, as the order in which display target charts corresponding to the text objects are displayed. Then, the display control apparatus 1 may determine a display layout such that the display target charts are arranged in the order of display and in the display sizes determined above, on the second display screen.

The display control apparatus 1 creates a display image in which the display target charts are arranged in the display layout determined in S205 and causes the created display image to be displayed on the second display screen (S206), and the process returns.

According to the display control apparatus 1 explained above, when a document including text and charts is viewed, charts corresponding to the text displayed on the first display screen are dynamically selected and displayed on the second display screen in accordance with the displayed text. As a result, regardless of the arrangement positions of the text and charts in the document, the text and the charts corresponding to the text may be simultaneously viewed. Thus, the visibility of the document is improved as compared with that in the case where the document is simply displayed.

### [2. Second Exemplary Embodiment]

Next, a second exemplary embodiment of the present invention will be explained. In the second exemplary embodiment, the display control apparatus 1 executes a process in which data to be a display target (display target data) is caused to be displayed on the first display screen and other data elements corresponding to data elements of the display target data displayed on the first display screen are caused to be displayed on the second display screen. Here, data may include at least any of sentences, diagrams, tables, mathematical expressions, pictures, and moving images, and data elements may indicate respective sentences, diagrams, tables, mathematical expressions, pictures, and moving images that constitute the data.

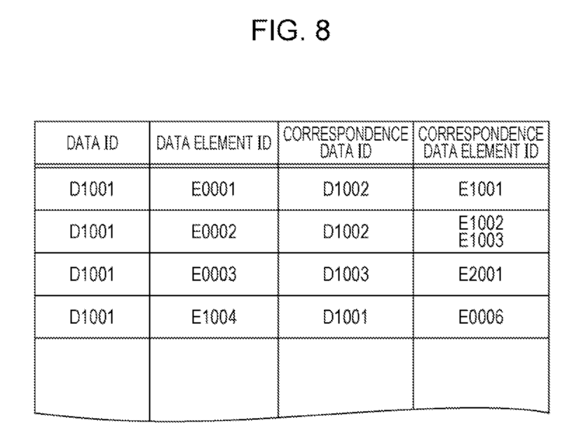

FIG. 8 illustrates an example of a data element correspondence table stored in the display control apparatus 1 according to the second exemplary embodiment. As illustrated in FIG. 8, a data ID for identifying data, a data element ID for identifying a data element included in the data, a correspondence data ID for identifying data (correspondence data) including a data element corresponding to the data element, a correspondence data element ID for identifying the data element (a correspondence data element) corresponding to the data element are associated with one another and stored in the data element correspondence table. Correspondence data corresponding to data of a correspondence source (original data) may include a piece of data or a plurality of pieces of data, and may also include the original data therein.

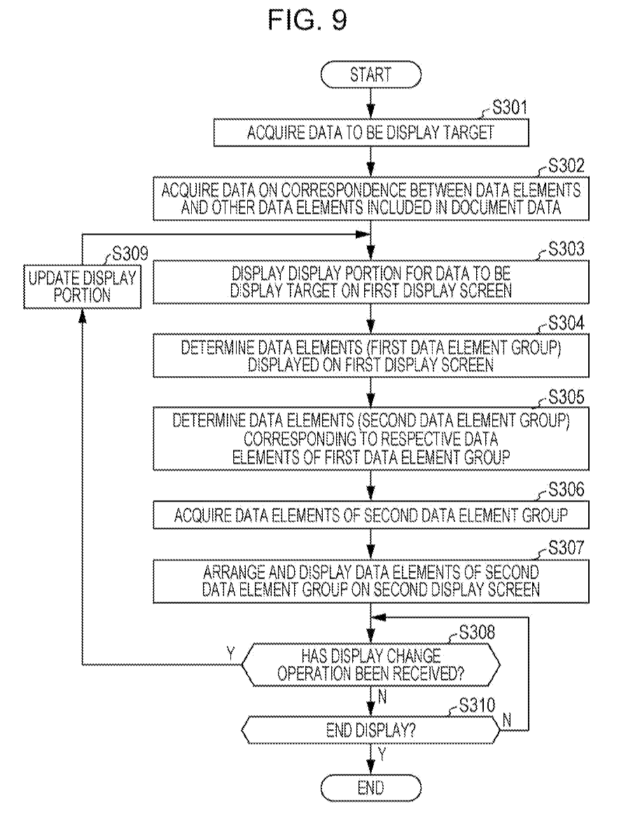

Next, an example of the flow of a display target data display process performed by the display control apparatus 1 will be explained with reference to FIG. 9.

As illustrated in FIG. 9, the display control apparatus 1 acquires data to be a display target (display target data) in accordance with an operation input received by the input receiving unit 14 (S301). In addition, the display control apparatus 1 reads and acquires data indicating a correspondence relationship between data elements and other data elements included in the display target data (a data element correspondence table) (S302), the other data elements corresponding to the respective data elements.

The display control apparatus 1 displays, on the first display screen, a display portion determined in the display target data in accordance with an operation input received by the input receiving unit 14 (S303) and determines one or a plurality of data elements (a first data element group) displayed on the first display screen (S304). Here, a data element displayed on the first display screen may be a data element at least a portion of which is displayed or may also be a data element the entirety of which is displayed.

The display control apparatus 1 determines one or a plurality of data elements (a second data element group) corresponding to the respective data elements included in the first data element group determined in S303, in accordance with the data element correspondence table determined for the display target data (S305). Then, the display control apparatus 1 acquires data on the data elements included in the second data element group determined in S205 (S306).

The display control apparatus 1 displays a display image in which the data elements included in the second data element group acquired in S306 are arranged, on the second display screen (S307). Note that a process similar to the process in which chart objects are displayed on the second display screen in the first exemplary embodiment may be applied to the process in which the data elements included in the second data element group are displayed on the second display screen.

In the case where a display change operation for changing display of the first display screen has been received by the input receiving unit 14 (S308: Y), the display control apparatus 1 updates a display portion of the display target data, the display portion being displayed on the first display screen, (S309) and the process returns to S303.

In the case where a display change operation has not been received by the input receiving unit 14 (S308: N) and in the case where display of the display target data is not ended (S310: N), the process returns to S308. In the case where display of the display target data is ended (S310: Y), the display control apparatus 1 ends display of the display target data and completes the process.

### [2-1. First Modified Example of Second Exemplary Embodiment]

Next, a modified example of the second exemplary embodiment will be explained.

A first modified example of the second exemplary embodiment relates to a process in which, in the case where data elements (the second data element group) included in one or more pieces of data are associated with the data elements (first data elements) included in the first data displayed on the first display screen, each data element included in the second data element group is caused to be displayed on the second display screen.

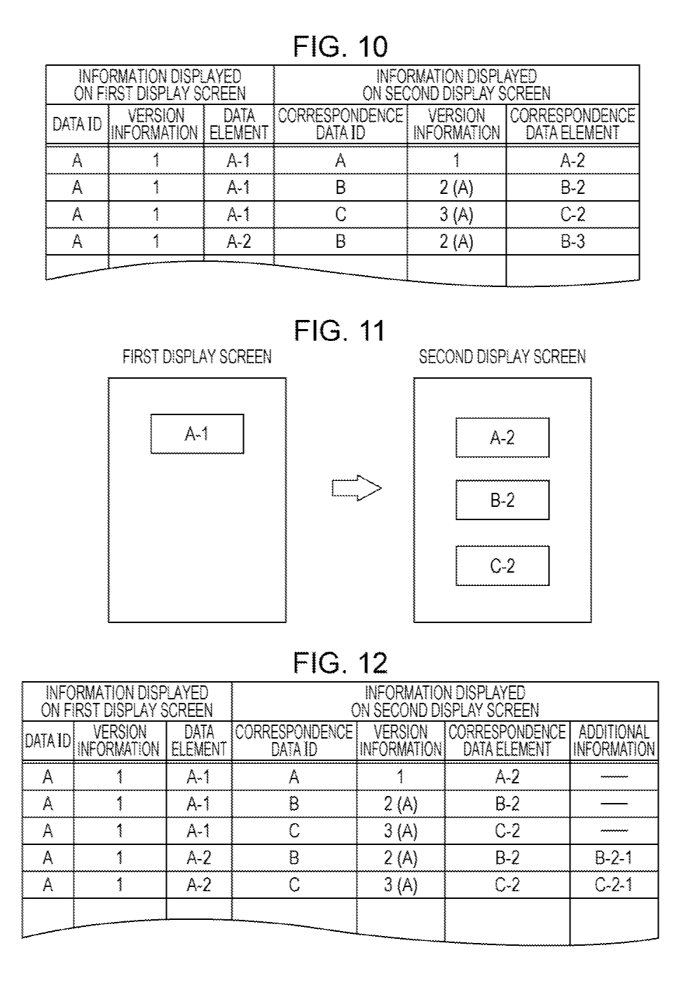

FIG. 10 illustrates an example of the data element correspondence table stored in the display control apparatus 1 according to the first modified example of the second exemplary embodiment. As illustrated in FIG. 10, a data ID for identifying data, version information on the data, a data element ID for identifying a data element included in the data, a correspondence data ID for identifying data (correspondence data) including a data element corresponding to the data element, version information on the correspondence data, and a correspondence data element ID for identifying the data element (a correspondence data element) corresponding to the data element are associated with one another and stored in the data element correspondence table. In the example illustrated in FIG. 10, data B and data C, which are correspondence data corresponding to data A (original data), are pieces of information having different data versions (editions) from each other.

FIG. 11 illustrates an example of display of the first display screen and the second display screen in accordance with the example of the data element correspondence table illustrated in FIG. 10. That is, as illustrated in FIG. 11, in the case where the display control apparatus 1 displays a data element A-1 of the data A on the first display screen, a data element A-2 of the data A, a data element B-2 of the data B, and a data element C-2 of the data C associated with the data element A-1 may be displayed on the second display screen.

### [2-2. Second Modified Example of Second Exemplary Embodiment]

A second modified example of the second exemplary embodiment relates to a process in which, additional information such as a note (an annotation), a comment, change history information, removable-note information, and the like added to a correspondence data element in the first modified example of the second exemplary embodiment is caused to be displayed on the second display screen.

For example, FIG. 12 illustrates an example of the data element correspondence table stored in the display control apparatus 1 according to the second modified example of the second exemplary embodiment. As illustrated in FIG. 12, a data ID for identifying data, version information on the data, a data element ID for identifying a data element included in the data, a correspondence data ID for identifying data (correspondence data) including a data element corresponding to the data element, version information on the correspondence data, a correspondence data element ID for identifying the data element (a correspondence data element) corresponding to the data element, and additional information added to the correspondence data element are associated with one another and stored in the data element correspondence table. In the example illustrated in FIG. 12, data B and data C, which are correspondence data corresponding to data A (original data), are pieces of information having different data versions from each other, and comment information, change history information, and the like are added as additional information to the data B and the data C by a user (a reviewer).

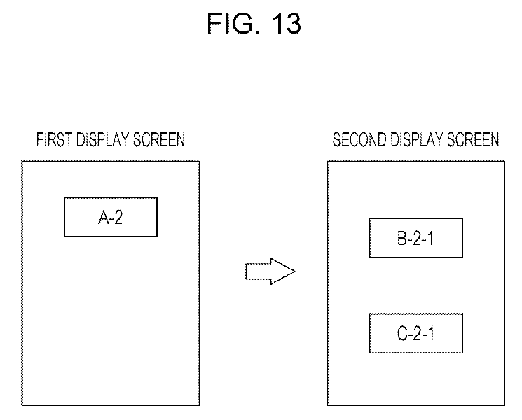

FIG. 13 illustrates an example of display of the first display screen and the second display screen in accordance with the example of the data element correspondence table illustrated in FIG. 12. That is, as illustrated in FIG. 13, in the case where the display control apparatus 1 displays a data element A-1 of the data A on the first display screen, a data element A-2 of the data A, additional information B-2-1 for a data element B-2 of the data B, and additional information C-2-1 for a data element C-2 of the data C associated with the data element A-1 may be displayed on the second display screen. In the example illustrated in FIG. 13, an example is illustrated in which only additional information is displayed on the second display screen; however, the data element B-2 and the data element C-2 may also be displayed on the second display screen.

In addition, the display control apparatus 1 may perform display by performing switching between a single display mode, a multi-display mode 1, and a multi-display mode 2. In the single display mode, only data elements within data the same as the data displayed on the first display screen are caused to be displayed on the second display screen. In the multi-display mode 1, data elements within data the same as the data displayed on the first display screen or within a data group including other data are caused to be displayed on the second display screen. In the multi-display mode 2, additional information associated with data elements within data the same as the data displayed on the first display screen or within a data group including other data is caused to be displayed on the second display screen.

### [3. Modified Example]

The present invention is not limited to the above-described exemplary embodiments. For example, the display control apparatus 1 may determine, in the case where a plurality of chart objects are associated with the same text object, the order in which the chart objects are displayed in accordance with the order in which pieces of identification information of the chart objects appear within the text object.

In addition, the display control apparatus 1 may display, in the case where the scrolling speed of the first display screen is greater than or equal to a threshold (or greater than the threshold), a display target chart on the second display screen in a simplified manner (for example, a portion of a frame or the like is displayed, meta-information is displayed, or the like).

In addition, the display control apparatus 1 may display, in the case where charts (chart objects) that are identical are determined in S107, such a chart repeatedly the number of times equal to the number of the charts or only once. In the case where display is performed in the latter method, the visibility may be improved since the number of charts is reduced, as compared with the case where the former method is used.

In addition, in the case where the display control apparatus 1 is equipped with a camera, a line-of-sight position of the user is determined on the first display screen in accordance with an image of the user captured by the camera, and an area of interest may be determined in accordance with the determined line-of-sight position in a text document displayed on the first display screen.

In addition, the display control apparatus 1 may execute a display process by performing switching between a mode in which a document is displayed in accordance with the original layout and a mode in which a document is separated into text and charts and displayed.

In addition, the first display screen and the second display screen do not have to be displayed on the same display apparatus. In this case, the display control apparatus 1 may transmit a display image to be displayed on the first display screen to a first display apparatus that displays the first display screen, and transmit a display image to be displayed on the second display screen to a second display apparatus that displays the second display screen.

In addition, the display control apparatus 1 may classify and display, on a plurality of display screens, other data elements corresponding to the data elements displayed on the first display screen.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A display control apparatus comprising:
an acquisition unit that acquires document information including a main body and information on one or a plurality of charts;
a first display control unit that causes at least a portion of the maim body included in the document information to be displayed on a first display screen; and
a second display control unit that causes, among the one or plurality of charts, a chart associated with the portion of the main body displayed on the first display screen to be displayed on a second display screen.

2. The display control apparatus according to claim 1, further comprising:
an association unit that associates, for sentence elements that constitute the main body, each sentence element with information on a chart associated with the sentence element and stores the sentence element and the information in a storage unit,
wherein the second display control unit causes a chart to be displayed on the second display screen, the chart being associated with sentence elements that constitute the portion of the main body displayed on the first display screen and being stored in the storage unit.

3. The display control apparatus according to 1, further comprising:
a determination unit that determines an order in which charts associated with the sentence elements are displayed, in accordance with an order in which the sentence elements that constitute the portion of the main body displayed on the first display screen are displayed,
wherein the second display control unit causes charts associated with the portion of the main body displayed on the first display screen to be displayed on the second display screen, in accordance with the order in which the charts are displayed, the order being determined by the determination unit.

4. The display control apparatus according to claim 1, further comprising:
a degree-of-attention determination unit that determines degrees of attention of the charts associated with the sentence elements, in accordance with display positions of the sentence elements that constitute the portion of the main body displayed on the first display screen,
wherein the second display control unit causes charts associated with the portion of the main body displayed on the first display screen to be displayed on the second display screen, in sizes corresponding to the degrees of attention of the charts determined by the degree-of-attention determination unit.

5. The display control apparatus according to claim 1, further comprising:
a maximum number determination unit that determines a maximum number of charts to be displayed on the second display screen, in accordance with an update speed of the portion of the main body displayed on the first display screen,
wherein the second display control unit narrows down charts associated with the portion of the main body displayed on the first display screen to the maximum number or less and causes resulting charts to be displayed on the second display screen.

6. The display control apparatus according to claim 1, wherein charts associated with the portion of the main body displayed on the first display screen are displayed on the second display screen in a simplified manner when an update speed of the portion of the main body displayed on the first display screen is equal to or greater than a threshold value.

7. A display control method comprising:
acquiring document information including a main body and information on one or a plurality of charts;
causing at least a portion of the maim body included in the document information to be displayed on a first display screen; and
causing, among the one or plurality of charts, a chart associated with the portion of the main body displayed on the first display screen to be displayed on a second display screen.

8. A non-transitory computer readable medium storing a program for causing a computer to execute an image processing process, the process comprising:
acquiring document information including a main body and information on one or a plurality of charts;
causing at least a portion of the main body included in the document information to be displayed on a first display screen; and
causing, among the one or plurality of charts, a chart associated with the portion of the main body displayed on the first display screen to be displayed on a second display screen.
